(19) United States
(12) Patent Application Publication
(10) Pub. No.: US 2021/0325003 A1
(43) Pub. Date: Oct. 21, 2021

(54) DEVICE AND METHOD FOR HEATING A FLUID IN A PIPELINE

(71) Applicant: BASF SE, Ludwigshafen am Rhein (DE)

(72) Inventors: Alexander WECK, Ludwigshafen am Rhein (DE); Heinrich LAIB, Ludwigshafen am Rhein (DE)

(21) Appl. No.: 17/268,743

(22) PCT Filed: Aug. 15, 2019
(86) PCT No.: PCT/EP2019/071970

§ 371 Date: Feb. 16, 2021

(30) Foreign Application Priority Data
Aug. 16, 2018 (EP) 18189369.4

(51) Int. Cl. F17D 1/18; H05B 6/10

(52) U.S. Cl. CPC F17D 1/18; F24H 2250/08; H05B 6/108

(57) ABSTRACT

An apparatus (112) for heating a fluid is proposed. The apparatus (112) comprises
at least one electrically conductive pipeline (120) for receiving the fluid
at least one electrically conductive coil (110)
at least one AC voltage source (114), which is connected to the coil (110) and is designed for an AC voltage to be applied to the coil (110).

The coil (110) is designed for generating at least one electromagnetic field by applying the AC voltage. The pipeline (120) and the coil (110) are arranged in such a way that the electromagnetic field of the coil (110) induces in the pipeline (120) an electrical current, which warms up the pipeline (120) by Joulean heat, which is produced when the electrical current passes through conducting pipe material, for heating the fluid.

The invention relates to an apparatus and a method for heating a fluid in a pipeline.

It is known to heat high-temperature processes in the chemical industry by direct firing. Most of these high-temperature processes use tubular furnaces, such as steam crackers, steam-methane reformers, dehydrogenation plants, platforming and others. The flue gas of these furnaces is generally the main source of CO₂ emissions of the respective process and, by contrast with material-based process-related CO₂ emission, for example from the water-gas shift reaction, can be avoided by coupling in the required process energy in the form of electrical energy. It is known that the pipes of these furnaces, which consist of electrically conductive metals, can be directly heated up by electrical currents.

For example, WO 2015/197181 A1 describes a device for heating a fluid with at least one electrically conductive pipeline for receiving the fluid, and at least one voltage source connected to the at least one pipeline. The at least one voltage source is designed for generating in the at least one pipeline an electrical current, which warms up the at least one pipeline for heating the fluid. The at least one voltage source has M outer conductors, M being a natural number greater than or equal to two. The at least one voltage source is designed for providing an AC voltage on the outer conductors. Those AC voltages are phase-shifted with respect to one another by 2π/M. The outer conductors are connected to the at least one pipeline in an electrically conducting manner so as to form a star circuit.

JPH08247546 A describes a pipeline which is formed by a flat, oval and wound pipe produced from metal. Heating coils which are shaped by helical winding along each curved surface are mounted on an inner circumferential surface and an outer circumferential surface of pipeline rows, a plurality of pipelines being installed next to one another.

However, such heating of the pipes by electrical current requires electrical insulation of the known highly optimized pipe suspensions, and also electrical contacting of the pipes for the introduction of the current. The material and cross section of the pipes are also substantially determined by the process conditions. However, on account of the necessary compressive strength, large cross sections can only result in small resistances, and consequently very high necessary currents at low voltage. Thus, large conductor cross sections of the feed lines may be necessary, which causes high losses in the same and complex high-current system parts and transformers.

The object of the present invention is therefore to provide an apparatus and a method for heating a fluid that at least largely avoid the disadvantages of known apparatuses and methods. In particular, the apparatus and method are intended to be technically simple to realize and easy to carry out and also inexpensive.

This object was achieved by an apparatus with the features of the independent claims. Preferred refinements of the apparatus are specified inter alia in the associated subclaims and dependency references of the subclaims.

In the following, the terms “have”, “comprise” or “include” or any grammatical variations thereof are used in a non-exclusive way. Accordingly, these terms may relate both to situations in which there are no further features apart from the feature introduced by these terms or to situations in which there is or are one or more further features. For example, the expression “A has B”, “A comprises B” or “A includes B” may relate both to the situation in which, apart from B, there is no further element in A (i.e. to a situation in which A exclusively consists of B) and to the situation in which, in addition to B, there is or are one or more further elements in A, for example element C, elements C and D or even further elements.

It is also pointed out that the terms “at least one” and “one or more” and grammatical variations of these terms or similar terms, when they are used in connection with one or more elements or features and are intended to express that the element or feature may be provided one or more times, are generally only used once, for example when the feature or element is introduced for the first time. When the feature or element is subsequently mentioned again, the corresponding term “at least one” or “one or more” is generally no longer used, without restricting the possibility that the feature or element may be provided one or more times.

Furthermore, in the following the terms “preferably”, “in particular”, “for example” or similar terms are used in connection with optional features, without alternative embodiments being restricted thereby. Thus, features that are introduced by these terms are optional features, and it is not intended to restrict the scope of protection of the claims, and in particular of the independent claims, by these features. Thus, as a person skilled in the art will appreciate, the invention can also be carried out by using other configurations. In a similar way, features that are introduced by “in an embodiment of the invention” or by “in an example of the invention” are understood as optional features, without it being intended that alternative configurations or the scope of protection of the independent claims are restricted thereby. Furthermore, all of the possibilities of combining the features thereby introduced with other features, whether optional or non-optional features, are intended to remain unaffected by these introductory expressions.

In a first aspect of the present invention, an apparatus for heating a fluid is proposed. Within the scope of the present invention, a “fluid” is understood as meaning a gaseous and/or liquid medium, for example a process gas. The fluid may for example be selected from the group consisting of: water, steam, a combustion air, a hydrocarbon mixture, a hydrocarbon to be cracked. For example, the fluid may be a hydrocarbon to be thermally and/or catalytically cracked, in particular a mixture of hydrocarbons to be thermally and/or catalytically cracked. For example, the fluid may be water or steam and additionally comprise a hydrocarbon to be thermally and/or catalytically cracked, in particular a mixture of hydrocarbons to be thermally and/or catalytically cracked. The fluid may for example be a preheated mixture of hydrocarbons to be thermally and/or catalytically cracked and steam. Other fluids are also conceivable.

“Heating a fluid” may be understood as meaning a process that leads to a change in a temperature of the fluid, in particular to a rise in the temperature of the fluid, for example to a warming up of the fluid. For example, by the heating, the fluid may be warmed up to a prescribed or predetermined temperature value. The prescribed or predetermined temperature value may be a high-temperature value. The apparatus may be designed to heat the fluid to a temperature in the range of 200° C. to 1100° C., preferably of 200° C. to 900° C., more preferably of 400° C. to 850° C. For example, the fluid may be heated to a temperature in the range of 550° C. to 700° C. For example, the fluid may be a combustion air of a reformer furnace which is prewarmed or heated up, for example to a temperature in the range of 200° C. to 900° C., preferably of 400° C. to 850° C. However, other temperatures and temperature ranges are also conceivable. The apparatus may have a heating capacity of ≥0.5 MW per pipeline, wherein the apparatus may have a pipeline system which may be composed of a plurality of pipelines.

The apparatus may be part of an installation. For example, the installation may be selected from the group consisting of: a steam cracker, a steam reformer, an apparatus for alkane dehydrogenation. For example, the installation may be designed for carrying out at least one process selected from the group consisting of: steam cracking, steam reforming, alkane dehydrogenation.

The apparatus may for example be part of a steam cracker. “Steam cracking” may be understood as meaning a process in which longer-chain hydrocarbons, for example naphtha, propane, butane and ethane, as well as gas oil and hydrowax, are converted into short-chain hydrocarbons by thermal cracking in the presence of steam. In steam cracking, hydrogen, methane, ethene and propene can be produced as the main product, as well as inter alia butenes and pyrolysis benzene. The steam cracker may be designed for warming up the fluid to a temperature in the range of 550° C. to 1100° C.

For example, the apparatus may be part of a reformer furnace. “Steam reforming” may be understood as meaning a process for producing steam and carbon oxides from water and carbon-containing energy carriers, in particular hydrocarbons such as natural gas, light gasoline, methanol, biogas and biomass. For example, the fluid may be warmed up to a temperature in the range of 200° C. to 800° C., preferably of 400° C. to 700° C.

For example, the apparatus may be part of an apparatus for alkane dehydrogenation. “Alkane dehydrogenation” may be understood as meaning a process for producing alkenes by dehydrogenating alkanes, for example dehydrogenating butane into butenes (BDH) or dehydrogenating propane into propene (PDH). The apparatus for alkane dehydrogenation may be designed for warming up the fluid to a temperature in the range of 400° C. to 700° C.

The apparatus comprises:
at least one electrically conductive pipeline for receiving the fluid
at least one electrically conductive coil
at least one AC voltage source, which is connected to the coil and is designed for an AC voltage to be applied to the coil.

The coil is designed for generating at least one electromagnetic field by applying the AC voltage. The pipeline and the coil are arranged in such a way that the electromagnetic field of the coil induces an electrical current in the pipeline. The electrical current, also known as an eddy current, warms up the pipeline by Joulean heat, which is produced when the electrical current passes through conducting pipe material, for heating the fluid.

In this way, the pipeline can also be warmed by fluids flowing through that are not electrically conductive.

Within the scope of the present invention, a pipeline may be understood as meaning any shaped device designed for receiving and transporting the fluid. The pipeline may be a process pipe. The pipeline may comprise at least one pipeline segment. A pipeline segment may be understood as meaning a part of a pipeline. The geometry and/or surfaces and/or material of the pipeline may be dependent on a fluid to be transported. An “electrically conductive pipeline” may be understood as meaning that the pipeline, in particular the material of the pipeline, is designed for conducting electrical current. The pipeline may be designed as a reaction pipe of a reformer furnace. The pipeline may be designed as a reaction pipe and/or as a tubular reactor.

The pipeline may in particular be designed such that chemical reactions are carried out and/or proceed therein.

The apparatus may comprise a plurality of pipelines. The apparatus may comprise L pipelines, L being a natural number greater than or equal to one. For example, the apparatus may comprise at least one, two, three, four, five or more pipelines. The apparatus may for example comprise up to several hundred pipelines. The pipelines may be configured identically or differently. The pipelines may comprise different numbers of legs or windings. The pipelines may comprise different numbers of branches. The pipelines may be configured as so-called single-pass or multi-pass pipes. The pipelines may comprise identical or different geometries and/or surfaces and/or materials. The pipelines may be through-connected, and thus form a substantially planar pipe system for receiving the fluid. A “pipe system” may be understood as meaning an apparatus comprising at least two pipelines, in particular connected to one another. A “substantially planar pipe system” may be understood as meaning an arrangement of the pipelines in one plane, slight deviations from a planar arrangement of less than 5%, preferably less than 1%, being possible. The pipe system may comprise incoming and outgoing pipelines. The pipe system may comprise at least one inlet for receiving the fluid. The pipe system may comprise at least one outlet for discharging the fluid. “Through-connected” may be understood as meaning that the pipelines are in fluid connection with one another. Thus, the pipelines may be arranged and connected in such a way that the fluid flows through the pipelines one after the other. The pipelines may be interconnected parallel to one another in such a way that the fluid can flow through at least two pipelines in parallel. The pipelines, in particular the pipelines connected in parallel, may be designed in such a way as to transport different fluids in parallel. In particular, the pipelines connected in parallel may comprise geometries and/or surfaces and/or materials that are different from one another for transporting different fluids. In particular for the transport of a fluid, a number or all of the pipelines may be configured as parallel, so that the fluid can be divided among those pipelines configured as parallel. Combinations of a series connection and a parallel connection are also conceivable.

“A coil” may be understood as meaning any desired element that has an inductance and is suitable for generating a magnetic field under the flow of a current, and/or vice versa. For example, a coil may comprise at least one complete or partially closed conductor loop or winding. An “electrically conductive coil” may be understood as meaning a coil that is configured in such a way that the coil generates a magnetic flux when an electrical voltage and/or an electrical current is applied. The electrically conductive coil may be an induction coil. The electrically conductive coil may comprise at least one conducting material, for example copper or aluminum. The winding form and number of windings of the coil may be selected in such a way that a maximum current intensity and/or maximum voltage and/or maximum frequency is achieved. In particular, greatly reduced currents with increased voltage may be possible in comparison with a direct resistance heating of pipelines.

The apparatus may comprise a plurality of coils. The apparatus may comprise M coils, M being a natural number greater than or equal to two. For example, the apparatus may comprise at least two, three, four, five or more coils. The coils may form a substantially planar coil array. A “coil array” may be understood as meaning a coil arrangement comprising at least two coils. A “substantially planar” coil array may be understood as meaning an arrangement of the coils in one plane, slight deviations from a planar arrangement of less than 5%, preferably less than 1%, being possible. The coil array may be adapted to a path followed by the pipeline. In particular, the coil array may be adapted to a path process heat requirement changing along the pipeline. For example, the coil array may be configured in such a way that an energy input adapted to the process and the path followed by the pipelines is possible.

An “AC voltage source” may be understood as meaning an apparatus which is designed for providing an AC voltage. An “AC voltage” may be understood as meaning a voltage of which the level and polarity are regularly repeated over time. For example, the AC voltage may be a sinusoidal AC voltage. The AC voltage source is connected to the coil, in particular electrically connected, and is designed for applying the AC voltage to the coil. The apparatus may comprise a plurality of AC voltage sources. In the case of an apparatus with a coil array, each coil or a group of coils may each be assigned an AC voltage source, which is connected to the respective coil and/or group of coils, in particular electrically by way of at least one electrical connection. The AC voltage sources may in each case be configured with a possibility of closed-loop control for adaptation of a level and/or frequency of the AC voltage. The AC voltage sources may be electrically controllable independently of one another. Thus, even complex changes of the energy input along the path followed by the pipeline, and consequently a precise control of the temperature field, may become possible.

The coil is designed for generating at least one electromagnetic field by applying the AC voltage. The coil is in particular designed for generating at least one electromagnetic field in response to the application of the AC voltage. The pipeline and the coil are arranged in such a way that the electromagnetic field of the coil induces an electrical current in the pipeline. In particular, a spacing of the pipeline and the coil may be such that the pipeline is arranged in the electromagnetic field of the coil. The electrical current thus generated in the pipeline may warm up the pipeline by Joulean heat, which is produced when the electrical current passes through conducting pipe material, for heating the fluid. “Warming up the pipeline” may be understood as meaning a process that leads to a change in a temperature of the pipeline, in particular a rise in the temperature of the pipeline.

The apparatus may comprise at least one heat insulator, which is designed for decoupling the coil, in particular the coil array, from the temperature of the pipeline, in particular the pipe system. A “heat insulator” may be understood as meaning an element which at least partially or completely prevents conduction of heat between the pipeline, in particular the pipe system, and the coil, in particular the coil array. For example, the substantially planar coil array may be embedded in an electrically non-conductive and non-magnetic heat insulating compound. The heat insulator may comprise at least one element selected from the group consisting of: ceramic fiber mats, a ceramic foam, refractory bricks, refractory concrete.

The coil may comprise at least one conductor pipe. A “conductor pipe” may be understood as meaning a device designed to be flowed through by a liquid and/or a gas. The apparatus may be designed for conducting at least one coolant through the conductor pipe. A heat loss of the coil and a heat input through the heat insulator from a process space, in which the pipelines are arranged, into the coils can thus be removed by direct cooling of the coils. For example, the coil may be configured from copper or aluminum pipes through which the coolant is conducted.

The conductor pipe may be of a pressure-resistant configuration. It may thus be possible to apply boiler feed water directly to the conductor pipe and to generate steam either in the conductor pipe directly or in an external steam drum after throttling the pressurized water from the conductor pipe. The steam may be used as process steam or machine steam.

The pipeline may be arranged in a gas space. A “gas space” may be understood as meaning a structural space which is designed for receiving at least one gas. In particular, the gas space may be a structural space through which gas can flow. The pipeline may be arranged freely suspended in the gas space. Thus, temperature-induced changes in length of the pipeline are not hindered. Suspensions and procedures are known to a person skilled in the art. A length and/or width and/or height of the gas space may be configured in such a way as to allow changes in the position and length of the pipeline and its suspension due to warming up. For example, the pipe system may define a plane. A “length” of the gas space may be an extent of the gas space horizontally in relation to the path followed by the pipe system. A “height” of the gas space may be an extent in the plane of the pipe system perpendicularly to the length of the gas space. A “width” of the gas space may be an extent of the gas space perpendicularly to the plane of the pipe system. By contrast with directly fired radiant boilers, a minimum gas layer thickness is not required, so that the width of the gas space may enclose the pipeline as closely as the changes in its position and length due to warming up allow, and/or that, in the case of a pipe rupture, the process gas can be safely removed in the plane of the planar pipe system. The apparatus may be designed for the gas space to be flowed through by a chemically inert and oxygen-free inert gas, for example nitrogen, in particular slowly. Thus, the pipeline can be protected from scaling, and at the same time possible minor leakages can be safely removed before large amounts of combustible gases accumulate. The apparatus may comprise at least one leakage detection device. The leakage detection device may be designed for monitoring a gas composition at an output of the gas space.

The apparatus may comprise a plurality of coil arrays and/or pipe systems. The coil arrays and the pipe systems may be arranged alternating in a horizontal direction in at least one stack. In particular, a coil array may be arranged in each case between two pipe systems. In one embodiment, the stack may comprise a coil array at one end, for example on a front side, the stack comprising pipe systems and further coil arrays alternating in a horizontal direction of the stack. A coil array or a pipe system may likewise be provided on a rear side of the stack. In one embodiment, the stack may comprise a pipe system on the front side, the stack comprising coil arrays and pipe systems alternating in a horizontal direction of the stack. A coil array or a pipe system may likewise be provided on a rear side of the stack. The apparatus may comprise a different number or the same number of pipe systems and coil arrays. For example, the apparatus may comprise N pipe systems and O coil arrays, N and O being natural numbers greater than or equal to two. For example, the apparatus may comprise at least two, three, four, five or more coil arrays and pipe systems. By such stacking of pipe systems and coil arrays, tubular furnaces of the required capacity can be assembled. By using the respective front-side and rear-side electromagnetic fields of coil arrays to the left and right of a pipe system for heating the pipe system, field losses can be kept low. A mutual intensification of the fields of the coil arrays to the left and right of a pipe system may also be advantageous. The symmetrical field around the respective pipe system may also be advantageous.

The stack may comprise at least one compensation coil array. A “compensation coil array” may be understood as meaning a coil array which is designed for keeping a front-side and/or rear-side electromagnetic field of the stack as small as possible. The stack may be closed off at the free ends by a combination of a pipeline or pipe system used for low temperatures, for example preheaters or reactant evaporators, and a compensation coil array in such a way that a residual external electromagnetic field is as small as possible.

The apparatus according to the invention is advantageous in particular because it combines a full mechanical and thermal decoupling of electrical heating and pipelines, an adoption to a great extent of tried-and-tested process pipe designs with heating operated at low temperature, for example in the coil plane 150 to 250° C., depending on the desired pressure of the steam generated, and use of the electrical losses in the form of process steam with improved and delay-free controllability.

Within the scope of the present invention, in a further aspect a method for heating a fluid is proposed. In the method, an apparatus according to the invention is used. The method comprises the following steps:
providing at least one electrically conductive pipeline for receiving the fluid
receiving the fluid in the pipeline
providing at least one coil
providing at least one AC voltage source, the coil being connected to the AC voltage source, and applying an AC voltage to the coil
generating at least one electromagnetic field by applying the AC voltage to the coil
inducing an electrical current in the pipeline by the electromagnetic field of the coil, which warms up the pipeline by Joulean heat, which is produced when the electrical current passes through conducting pipe material, for heating the fluid.

Providing the at least one coil may comprise providing at least one coil produced from a conductor through which cooling fluid can flow.

With regard to embodiments and definitions, reference can be made to the above description of the apparatus. The method steps may be carried out in the sequence specified, it also being possible for one or more of the steps to be carried out at least partially simultaneously and it being possible for one or more of the steps to be repeated a number of times. In addition, further steps may be additionally performed, irrespective of whether or not they have been mentioned in the present application.

To sum up, the following embodiments are particularly preferred within the scope of the present invention:

Embodiment 1: An apparatus for heating a fluid, comprising
at least one electrically conductive pipeline for receiving the fluid;
at least one electrically conductive coil;
at least one AC voltage source, which is connected to the coil and is designed for applying an AC voltage to the coil; the coil being designed for generating at least one electromagnetic field by applying the AC voltage, the pipeline and the coil being arranged in such a way that the electromagnetic field of the coil induces in the pipeline an electrical current, which warms up the pipeline by Joulean heat, which is produced when the electrical current passes through conducting pipe material, for heating the fluid.

Embodiment 2: The apparatus according to the preceding embodiment, wherein the apparatus comprises a plurality of coils, the coils forming a substantially planar coil array.

Embodiment 3: The apparatus according to the preceding embodiment, the coil array being adapted to a path followed by the pipeline.

Embodiment 4: The apparatus according to one of the two preceding embodiments, wherein the apparatus comprises a plurality of AC voltage sources, each coil of the coil array being assigned an AC voltage source, the AC voltage sources in each case being configured with a possibility of closed-loop control for adaptation of a level and/or frequency of the AC voltage, the AC voltage sources being electrically controllable independently of one another.

Embodiment 5: The apparatus according to one of the preceding embodiments, wherein the apparatus comprises a plurality of pipelines, the pipelines being through-connected and thus forming a substantially planar pipe system for receiving the fluid.

Embodiment 6: The apparatus according to the preceding embodiment, wherein the apparatus comprises a plurality of coil arrays and/or pipe systems, the coil arrays and the pipe systems being arranged alternating in a horizontal direction in at least one stack.

Embodiment 7: The apparatus according to one of the preceding embodiments, wherein the apparatus comprises at least one heat insulator, which is designed for decoupling the coils from the temperature of the pipeline, the heat insulator comprising at least one element selected from the group consisting of: ceramic fiber mats, a ceramic foam, refractory bricks, refractory concrete.

Embodiment 8: The apparatus according to one of the preceding embodiments, wherein the coil comprises at least one conductor pipe, the apparatus being designed for conducting at least one coolant through the conductor pipe.

Embodiment 9: The apparatus according to the preceding embodiment, wherein the conductor pipe is of a pressure-resistant configuration.

Embodiment 10: The apparatus according to one of the preceding embodiments, wherein the pipeline is arranged in a gas space, the pipeline being arranged freely suspended in the gas space.

Embodiment 11: The apparatus according to the preceding embodiment, wherein a length and/or width and/or height of the gas space is configured in such a way as to allow changes in the position and length due to warming up.

Embodiment 12: The apparatus according to one of the two preceding embodiments, wherein the apparatus is designed for the gas space to be flowed through by a chemically inert and oxygen-free inert gas.

Embodiment 13: The apparatus according to one of the three preceding embodiments, wherein the apparatus comprises at least one leakage detection apparatus, the leakage detection apparatus being designed for monitoring a gas composition at an output of the gas space.

Embodiment 14: An installation comprising at least one apparatus according to one of the preceding embodiments.

Embodiment 15: The installation according to the preceding embodiment, wherein the installation is selected from the group consisting of: a steam cracker, a steam reformer, an apparatus for alkane dehydrogenation.

Embodiment 16: A method for heating a fluid by using an apparatus according to one of the preceding embodiments, the method comprising the following steps:
providing at least one electrically conductive pipeline for receiving the fluid;
receiving the fluid in the pipeline;
providing at least one electrically conductive coil;
providing at least one AC voltage source, the coil being connected to the AC voltage source, and applying an AC voltage to the coil;
generating at least one electromagnetic field by applying the AC voltage to the coil;
inducing an electrical current in the pipeline by the electromagnetic field of the coil, which warms up the pipeline by Joulean heat, which is produced when the electrical current passes through conducting pipe material, for heating the fluid.

Embodiment 17: The method according to the preceding embodiment, the providing of the at least one coil comprising providing at least one coil produced from a conductor through which cooling fluid can flow.

### BRIEF DESCRIPTION OF THE FIGURES

Further details and features of the invention may be found in the following description of preferred examples, in particular in conjunction with the subclaims. The respective features may be implemented separately, or several of them may be implemented in combination with one another. The invention is not restricted to the examples. The examples are diagrammatically represented in the figures. References which are the same in the individual figures denote elements which are the same or have the same function, i.e. they correspond to one another in respect of their functions.

Specifically:

FIGS. 1A and 1B show diagrammatic representations of an example of a coil according to the invention and an example of a coil array according to the invention;

FIG. 2 shows a diagrammatic representation of an example of a pipe system according to the invention; and

FIGS. 3A and 3B show an exploded drawing of an example of an apparatus according to the invention and a perspective representation of a further example of the apparatus.

### EXAMPLES

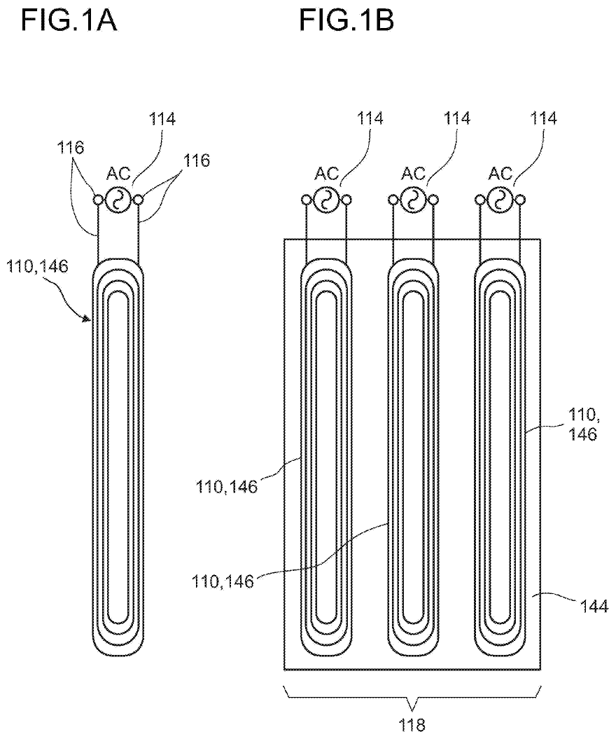

FIG. 1A shows a diagrammatic representation of an example of an electrically conductive coil 110 according to the invention of an apparatus 112 for heating at least one fluid. The fluid may for example be selected from the group consisting of: water, steam, a combustion air, a hydrocarbon mixture, a hydrocarbon to be cracked. For example, the fluid may be a hydrocarbon to be thermally cracked, in particular a mixture of hydrocarbons to be thermally cracked. For example, the fluid may be water or steam and additionally comprise a hydrocarbon to be thermally cracked, in particular a mixture of hydrocarbons to be thermally cracked. The fluid may for example be a preheated mixture of hydrocarbons to be thermally cracked and steam. Other fluids are also conceivable. For example, by the heating, the fluid may be warmed up to a prescribed or predetermined temperature value. The prescribed or predetermined temperature value may be a high-temperature value. For example, the fluid may be heated to a temperature in the range of 550° C. to 700° C. For example, the fluid may be a combustion air of a reformer furnace which is prewarmed or heated up, for example to a temperature in the range of 200° C. to 800° C., preferably of 400° C. to 700° C. However, other temperatures and temperature ranges are also conceivable.

The coil 110 may comprise at least one complete or partially closed conductor loop or winding. The coil 110 may generate a magnetic flux when an electrical voltage and/or an electrical current is applied. The electrically conductive coil may be an induction coil. The electrically conductive coil 110 may comprise at least one conducting material, for example copper or aluminum. The coil 110 may be constructed from tubular conductors that are flowed through by cooling medium. The winding form and number of windings of the coil may be selected in such a way that a maximum current intensity and/or maximum voltage and/or maximum frequency is achieved.

The apparatus 112 comprises at least one AC voltage source 114. The AC voltage source 114 is connected to the coil 110, in particular electrically connected. The apparatus 112 may comprise for this purpose at least one connecting element 116, for example a terminal and/or a feed line, which electrically connects the coil 110 and the AC voltage source 114. The AC voltage source 114 is designed for applying an AC voltage to the coil 110. The coil 110 is designed for generating at least one electromagnetic field in response to the application of the AC voltage.

The apparatus 112 may comprise a plurality of coils 110. The apparatus 112 may comprise M coils 110, M being a natural number greater than or equal to two. For example, the apparatus 112 may comprise at least two, three, four, five or more coils 110. The coils 110 may form a substantially planar coil array 118. An example of a coil array 118 is shown by FIG. 1B. The apparatus 112 may comprise a plurality of AC voltage sources 114. In the case of an apparatus 112 with a coil array 118, each coil 110 or a group of coils 110 may each be assigned an AC voltage source 114, which is connected to the respective coil 110 and/or group of coils 110, in particular electrically by way of at least one electrical connection. The AC voltage sources 114 may in each case be configured with a possibility of closed-loop control for adaptation of a level and/or frequency of the AC voltage. The AC voltage sources 114 may be electrically controllable independently of one another.

The apparatus 112 at least one electrically conductive pipeline 120 for receiving the fluid. The pipeline 120 may be a process pipe. The pipeline 120 may be designed as a reaction pipe of a reformer furnace. The pipeline 120 may comprise at least one pipeline segment. The geometry and/or surfaces and/or material of the pipeline 120 may be dependent on a fluid to be transported. The apparatus 112 may comprise a plurality of pipelines 120. The apparatus 112 may comprise L pipelines 112, L being a natural number greater than or equal to two. For example, the apparatus 112 may comprise at least two, three, four, five or more pipelines 120. The apparatus 112 may for example comprise up to several hundred pipelines 120. The pipelines 120 may be configured identically or differently. The pipelines 120 may comprise different numbers of legs or windings. The pipelines 120 may comprise different numbers of branches. The pipelines 120 may be configured as so-called single-pass or multi-pass pipes.

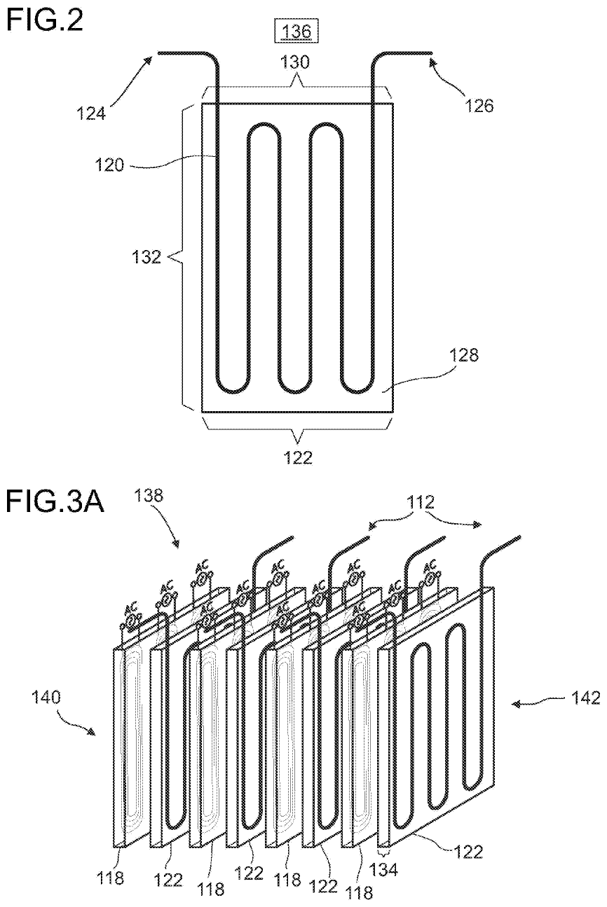

The pipelines 120 may comprise identical or different geometries and/or surfaces and/or materials. The pipelines 120 may be through-connected, and thus form a substantially planar pipe system 122 for receiving the fluid. An example of a pipe system 122 is shown by FIG. 2. The pipe system 122 may comprise incoming and outgoing pipelines 120. The pipe system 122 may comprise at least one inlet 124 for receiving the fluid. The pipe system 122 may comprise at least one outlet 126 for discharging the fluid. The pipelines 120 may be arranged and connected in such a way that the fluid flows through the pipelines 120 one after the other. The pipelines 120 may be interconnected parallel to one another in such a way that the fluid can flow through at least two pipelines 120 in parallel. The pipelines 120, in particular the pipelines 120 connected in parallel, may be designed in such a way as to transport different fluids in parallel. In particular, the pipelines 120 connected in parallel may comprise geometries and/or surfaces and/or materials that are different from one another for transporting different fluids. In particular for the transport of a fluid, a number or all of the pipelines 120 may be configured as parallel, so that the fluid can be divided among those pipelines 120 configured as parallel. Combinations of a series connection and a parallel connection are also conceivable.

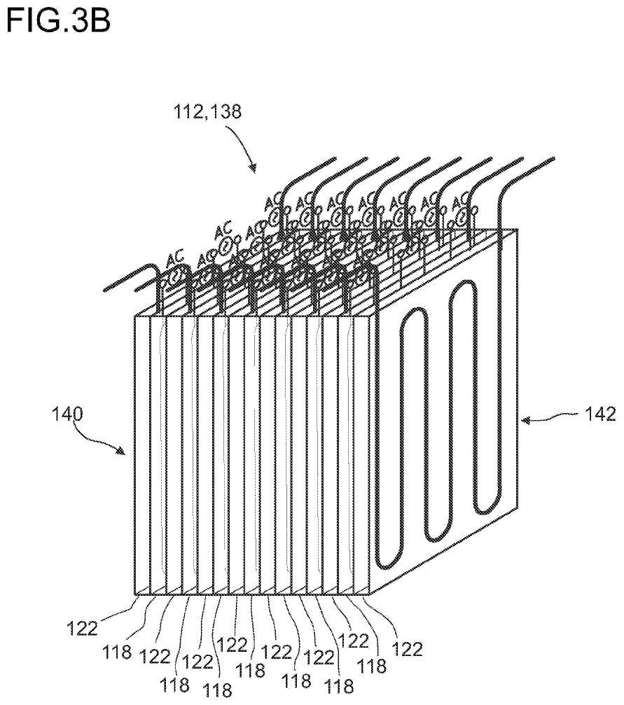

The pipeline 120 may be arranged in a gas space 128. The pipeline 120 may be arranged freely suspended in the gas space 128. Thus, temperature-induced changes in length of the pipeline 120 can be made possible. Suspensions and procedures are known to a person skilled in the art. A length 130 and/or height 132 and/or width 134 of the gas space 128 may be configured in such a way as to allow changes in position and length due to warming up. For example, the pipe system 122 may define a plane. The length 130 of the gas space 128 may be an extent of the gas space 128 horizontally in relation to the path followed by the pipe system 122. The height 132 of the gas space 128 may be an extent in the plane of the pipe system 122 perpendicularly to the length 130 of the gas space 128. The width 134 of the gas space 128 may be an extent of the gas space 128 perpendicularly to the plane of the pipe system 122, see for example FIG. 3A. By contrast with directly fired radiant boilers, a minimum gas layer thickness is not required, so that the width 134 of the gas space 128 may enclose the pipeline 120 as closely as the changes in its position and length due to warming up allow, and/or that, in the case of a pipe rupture, the process gas can be safely removed in the plane of the planar pipe system 122. The apparatus 122 may be designed for the gas space 128 to be flowed through by a chemically inert and oxygen-free inert gas, for example nitrogen, in particular slowly. Thus, the pipeline 120 can be protected from scaling, and at the same time possible minor leakages can be safely removed before large amounts of combustible gases accumulate. The apparatus 112 may comprise at least one leakage detection device 136. The leakage detection device 136 may be designed for monitoring a gas composition at an output of the gas space 128.

FIGS. 3A and 3B show by way of example two examples of the apparatus 112, in an exploded drawing (FIG. 3A) and in a perspective representation (FIG. 3B). The coil 110 is designed for generating at least one electromagnetic field by applying the AC voltage. The pipeline 120 and the coil 110 are arranged in such a way that the electromagnetic field of the coil 110 induces an electrical current in the pipeline 120. In particular, a spacing of the pipeline 120 and the coil 110 may be such that the pipeline 120 is arranged in the electromagnetic field of the coil 110. The electrical current warms up the pipeline 120 by Joulean heat, which is produced when the electrical current passes through conducting pipe material, for heating the fluid.

The apparatus 112 may comprise a plurality of coil arrays 118 and/or pipe systems 122. The coil array 118 may be adapted to a path followed by the pipeline 122. In particular, the coil array 118 may be adapted to a path process heat requirement changing along the pipeline 120. For example, the coil array 118 may be configured in such a way that an energy input adapted to the process and the path followed by the pipelines 120 is possible.

The coil arrays 118 and the pipe systems 122 may be arranged alternating in a horizontal direction in at least one stack 138. In particular, a coil array 118 may be arranged in each case between two pipe systems 122. In the embodiment shown in FIG. 3A, the stack 138 may comprise a coil array 118 at one end, for example on a front side 140, the stack 138 comprising pipe systems 122 and further coil arrays 118 alternating in a horizontal direction of the stack 138. A pipe system 122 may be arranged on a rear side 142 of the stack 138. However, embodiments with a terminating coil array 118 are also conceivable. In the embodiment shown in FIG. 3B, the stack 138 may comprise a pipe system 122 on the front side 140 and the rear side 142, the stack 138 comprising coil arrays 118 and pipe systems 122 alternating in a horizontal direction of the stack 138. The apparatus 112 may comprise a different number or the same number of pipe systems 122 and coil arrays 118. For example, the apparatus 112 may comprise N pipe systems 122 and O coil arrays 118, N and O being natural numbers greater than or equal to two. For example, the apparatus 112 may comprise at least two, three, four, five or more coil arrays 118 and pipe systems 122. By such stacking of pipe systems 122 and coil arrays 118, tubular furnaces of the required capacity can be assembled. By using the respective front-side and rear-side electromagnetic fields of coil arrays 118 to the left and right of a pipe system 122 for heating the pipe system 122, field losses can be kept low. A mutual intensification of the fields of the coil arrays 118 to the left and right of a pipe system 122 may also be advantageous. The symmetrical field around the respective pipe system 122 may also be advantageous.

The stack 138 may comprise at least one compensation coil array. The compensation coil array may be designed for keeping a front-side and/or rear-side electromagnetic field of the stack 138 as small as possible. The stack may be closed off at the free ends by a combination of a pipeline or pipe system used for low temperatures, for example preheaters or reactant evaporators, and a compensation coil array in such a way that a residual external electromagnetic field is as small as possible. For example, the last coil array 118 of the stack 138 in each case may be configured as a compensation coil array.

The apparatus 112 may comprise at least one heat insulator 144, see for example FIG. 1B, which is designed for decoupling the coil 110, in particular the coil array 118, from the temperature of the pipeline 120, in particular the pipe system 122. For example, the substantially planar coil array 118 may be embedded in an electrically non-conductive and non-magnetic heat insulating compound. The heat insulator 144 may comprise at least one element selected from the group consisting of: ceramic fiber mats, a ceramic foam, refractory bricks, refractory concrete.

The coil 110 may comprise at least one conductor pipe 146, see for example FIGS. 1A and 1B. The apparatus 112 may be designed for conducting at least one coolant through the conductor pipe 146. A power loss of the coil and a heat input through the heat insulator 144 from a process space, in which the pipelines 120 are arranged, into the coils 110 can be removed by direct cooling of the coils 110. For example, the coil 110 may be configured from copper or aluminum pipes through which the coolant is conducted. The conductor pipe 146 may be of a pressure-resistant configuration. It may thus be possible to apply boiler feed water directly to the conductor pipe 146 and to generate steam either in the conductor pipe 146 directly or in an external steam drum after throttling the pressurized water from the conductor pipe 146. The steam may be used as process steam or machine steam.

### LIST OF REFERENCE SIGNS

110 Coil
112 Apparatus
114 AC voltage source
116 Connecting element
118 Coil array
120 Pipeline
122 Pipe system
124 Inlet
126 Outlet
128 Gas space
130 Length
132 Height
134 Width
136 Leakage detection device
138 Stack
140 Front side
142 Rear side
144 Heat insulator
146 Conductor pipe

1.-15. (canceled)

16. An apparatus for heating a fluid, the apparatus being part of an installation, the installation being configured to carry out at least one process selected from the group consisting of: steam cracking; steam reforming; and alkane dehydrogenation, the apparatus comprising:
at least one electrically conductive pipeline for receiving the fluid
at least one electrically conductive coil,
at least one AC voltage source, which is connected to the coil and is designed for an AC voltage to be applied to the coil,
the coil being configured to generate at least one electromagnetic field by applying the AC voltage, the pipeline and the coil being arranged in such a way that the electromagnetic field of the coil induces in the pipeline an electrical current, which warms up the pipeline by Joulean heat, which is produced when the electrical current passes through conducting pipe material, for heating the fluid.

17. The apparatus according to claim 16, wherein the apparatus comprises a plurality of coils, the coils forming a substantially planar coil array.

18. The apparatus according to claim 17, wherein the coil array is adapted to a path followed by the pipeline.

19. The apparatus according to claim 17, wherein the apparatus comprises a plurality of AC voltage sources, each coil of the coil array being assigned an AC voltage source, the AC voltage sources being electrically controllable independently of one another.

20. The apparatus according to claim 16, wherein the apparatus comprises a plurality of pipelines, the pipelines being through-connected and thus forming a substantially planar pipe system for receiving the fluid.

21. The apparatus according to claim 16, wherein the apparatus comprises a plurality of coil arrays and/or pipe systems, the coil arrays and the pipe systems being arranged alternating in a horizontal direction in at least one stack.

22. The apparatus according to claim 16, wherein the apparatus comprises at least one heat insulator, configured to decouple the at least one coil from the temperature of the pipeline, the heat insulator comprising at least one element selected from the group consisting of: ceramic fiber mats, a ceramic foam, refractory bricks, refractory concrete.

23. The apparatus according to claim 16, wherein the coil comprises at least one conductor pipe, the apparatus being designed for conducting at least one coolant through the conductor pipe.

24. The apparatus according to claim 23, wherein the conductor pipe is of a pressure-resistant configuration.

25. The apparatus according to claim 16, wherein the pipeline is arranged in a gas space, the pipeline being arranged freely suspended in the gas space.

26. The apparatus according to claim 25, wherein a length and/or width and/or height of the gas space is configured in such a way as to allow changes in the position and length due to warming up.

27. The apparatus according to claim 25, wherein the apparatus is designed for the gas space to be flowed through by a chemically inert and oxygen-free inert gas.

28. The apparatus according to claim 25, wherein the apparatus comprises at least one leakage detection device, the leakage detection device being designed for monitoring a gas composition at an output of the gas space.

29. An installation comprising at least one apparatus according to claim 16, the installation being selected from the group consisting of: a steam cracker, a steam reformer, an apparatus for alkane dehydrogenation.

30. A method for heating a fluid by using an apparatus according to claim 16, the method comprising the following steps:
providing at least one electrically conductive pipeline for receiving the fluid,
receiving the fluid in the pipeline,
providing at least one electrically conductive coil,
providing at least one AC voltage source, the coil being connected to the AC voltage source, and applying an AC voltage to the coil,
generating at least one electromagnetic field by applying the AC voltage to the coil,
inducing an electrical current in the pipeline by the electromagnetic field of the coil, which warms up the pipeline by Joulean heat, which is produced when the electrical current passes through conducting pipe material, for heating the fluid.

31. The apparatus according to claim 19, wherein the AC voltage sources are configured to implement closed-loop control for adaptation of a level and/or frequency of the AC voltage.
